(19) United States
(12) Patent Application Publication
(10) Pub. No.: US 2002/0150214 A1
(43) Pub. Date: Oct. 17, 2002

(54) X-ray installation with wireless communication betwwen the radiation receiver and control unit

(75) Inventor: Martin Spahn, Erlangen (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/123,769

(22) Filed: Apr. 16, 2002

(30) Foreign Application Priority Data
Apr. 17, 2001 (DE) 10118745.9

(51) Int. Cl. H01J 31/49; H01J 31/50

(52) U.S. Cl. 378/189

(57) ABSTRACT

An X-ray installation has a radiation source and a transportable radiation receiver in the form of a solid state detector, and a mobile central control device, the transportable radiation receiver communicates for information transmission via a wireless communication link.

### BACKGROUND OF THE INVENTION

1. Field of the Invention

The present invention is directed to an X-ray installation of the type having a radiation source and a radiation receiver in the form of a solid state detector, and a central control device.

2. Description of the Prior Art

X-ray installations of the above general type are well known and particularly serve for the implementation of medical examinations. Solid-state detectors for X-ray imaging have been known for a number of years. Such a detector is based on an active read-out matrix, for example, composed of amorphous silicon (a-Si). The image information is converted in an X-ray converter, for example caesium iodide (CsI), and is stored as electrical charge in the photodiodes of the read-out matrix, and is subsequently read out via an active switch element having dedicated electronics and is converted from analog form to digital form. Such solid-state detectors are employed as flat image detectors in, for example, projection radiography mammography and angiography/cardiology.

For critical-care X-ray diagnostic applications such as, for example, X-ray diagnostic examination of bed-ridden patients, for example to obtain lung exposures, etc., or in the field of trauma diagnostics, film-foil systems and storage foil systems are currently utilized rather than solid-state detectors. This is particularly due to the simple handling of the cassettes. The cassettes are introduced into rack compartments that are arranged under the patient table. A solid-state detector, by contrast, requires a variety of cable connections (data transfer, communication, voltage supply) and therefore has conventionally been considered ill-suited for these applications.

### SUMMARY OF THE INVENTION

An object of the present invention is to provide an X-ray installation having a solid-state detector that is suitable for such critical-care application situations as well:

This object is inventively achieved in an X-ray installation of the type initially described wherein a transportable radiation receiver communicates for information transmission via a wireless communication link with a mobile control unit.

The invention thus provides a transportable, small-format and portable radiation receiver which can be positioned independently (i.e., without any mechanical or electrical connections for information transmission) from the other installation components (for example, a C-arm at which the radiation source and the radiation receiver are ordinarily arranged). This radiation receiver thus can be unproblemmatically placed or brought to positions or into positions that could not be assumed if it were a component of a known, rigid system.

Moreover, in accordance with the invention the radiation receiver wirelessly communicates with the control device, i.e. the signal transmission of the image signals registered with the radiation receiver to the control device, that receives these and processes them in the desired fashion, no longer ensues via cables as in the prior art, but instead, ensues wirelessly. All cable connections, that are complicated and are usually in the way and prevent an arbitrary positioning of the radiation receiver relative to the control device, thus are eliminated. The radiation receiver, consequently, can be moved in space without limitation as to the degrees of freedom, and critical-care and emergency exposure situations can consequently be easily covered. Due to the elimination of the cables, the technician or physician can be positioned and work without impediments. This produces the important advantage that the same digital-generating technology can be employed as in those applications wherein the cables do not represent problems. It is thus no longer necessary to keep specific film-foil systems or storage foil systems as well as the appertaining peripheral devices on hand for these specific applications. This is particularly advantageous for clinical applications since any arbitrary exposure situation can be processed with one system.

Transmission and reception units for a bidirectional communication are advantageously provided at the radiation receiver and at the control device, respectively. Corresponding control signals for input of an operating status, the implementation of a reset, synchronization with the radiation source, etc., can be provided via the control device to the electronics integrated in the radiation receiver, and the radiation receiver can in turn provide corresponding answerbacks. After the image registration has ensued, the image signals that have been read out and converted are transmitted wirelessly from the radiation receiver to the control device.

In an embodiment of the invention, the wireless communication is a radio connection, with the transmission and reception units fashioned for the transmission of the signals in the form of blue tooth signals or DECT signals. However, any mobile radio telephone technique is suitable that enables a complete and fast transmission of the relevant signals between the transmission and reception units.

Alternatively, the transmission and reception units can be fashioned for optical signal transmission. This, for example, can ensue by means of an infrared transmitter and receiver. Any optical transmission technique can be utilized that enables a dependable and fast signal transmission, and thus data transmission.

It is possible to provide a mains plug cable (power input) or connection receptacle for a mains plug cable at the radiation receiver as the only cable connection. It is preferable, however, to provide an integrated power supply at the radiation receiver, i.e. so that it completely independent from a hard wired supply network. This allows the most complete application and positioning freedom of the radiation receiver. The integrated power supply can be formed by one or more batteries, but accumulators are preferable for economic reasons.

When accumulators are employed, it is expedient when a charging station is provided to which the radiation receiver can be connected as needed for charging the accumulators. This charging station is expediently provided directly at the X-ray installation, for example, at the central control device. When the accumulators are depleted, which can be indicated by suitable display means at the radiation receiver (for example, light-emitting diodes or sound generators, etc.) or by a corresponding display means at the control device, then the radiation receiver is merely placed in the charging station, where the accumulators are automatically charged.

Alternatively or additionally, components for the inductive or capacitive feed of the supply voltage can be provided at the radiation receiver. These provide a supply voltage when, for example, an external magnetic field is adjacent thereto, which may be generated by suitable field generation devices.

In addition to an integrated power supply and/or the components for capacitative or inductive feed, further, a detachable connection for connecting the radiation receiver to a supply network can be provided as warranted. Preferably only one connecting socket is provided at the radiation receiver for this purpose, so that the connection can be unplugged as needed. This has the advantage that the radiation receiver can be unproblemmatically operated via the supply network in situations where a mains cable is not a disturbing factor. This is also possible for application of the radiation receiver with a prone patient, since suitable sockets are usually provided at patient support tables.

Alternatively, the radiation receiver with an integrated power supply or components for the inductive or capacitative feed can be introduced into a drawer of a Bucky table, i.e. a patient support table equipped with a Bucky drawer, and can be detachably connected to an external power supply upon introduction thereinto. This embodiment of the invention allows known Bucky tables to be employed that have proven to be practical in use, for example for lung exposures of a patient's bed, whereby the radiation receiver is merely introduced into the drawer and is pushed under the patient. When a connection to an external power supply is thereby made at the same time, then it is possible to operate the radiation receiver via the external power supply given this application. When the radiation receiver is taken from the drawer, then it is expedient for it to automatically switch to a mode upon removal wherein, for example, it is supplied via the integrated power supply. A charging station for charging accumulators of the introduced radiation receiver also can be provided in the drawer of the table. These accumulators, however, can be directly charged via the external power supply as an alternative. In any case, a corresponding connection is provided at the radiation receiver for coupling the radiation receiver to the charging station or the external power supply.

### DESCRIPTION OF THE DRAWINGS

FIG. 1 is a schematic illustration of an inventive X-ray installation in a first embodiment.

FIG. 2 is a schematic illustration of a radiation receiver in accordance with the invention.

FIG. 3 is a schematic illustration of an inventive X-ray installation in a second embodiment.

### DESCRIPTION OF THE PREFERRED EMBODIMENTS

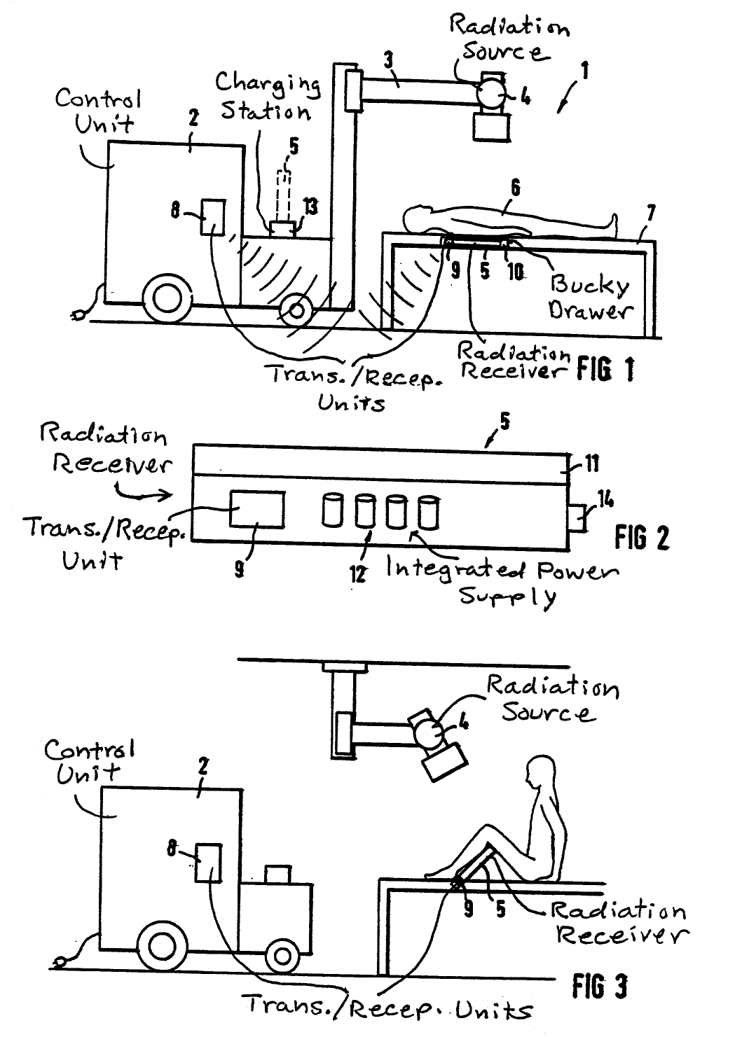

FIG. 1 shows an inventive X-ray installation 1 having a central control device 2 as well as a radiation source 4 arranged at a bracket 3. The radiation source 4 has a transportable radiation receiver 5 that can be positioned remote from the central control device 2. X-ray images of a patient 6, who lies on a patient table 7 here, are registered by the radiation receivers in a known way.

The control device 2 has a transmission and reception unit 8, and a corresponding transmission and reception unit 9 is provided at the radiation receivers. Both transmission and reception units 8, 9 are fashioned as radio devices that communicate with one another, preferably bidirectionally, via blue tooth signals or corresponding interfaces.

When, after positioning of the movable control device 2 and the radiation source 4 shown in the exemplary embodiment, an X-ray beam is applied to the patient 6, then corresponding, digital electrical signals that are available pixel-by-pixel are obtained in the radiation receiver 5, which is a known solid state radiation detector. Such solid-state detectors are known and their structure and function therefore need not be discussed in greater detail. The individual pixel-specific signals are then sent with the unit 9 acting as a transmitter to the unit 8 of the control device 2 acting as a receiver, where the signals are received and further-processed.

No disturbing cables are present since the radiation receiver 5 communicates wirelessly with the control device 2. As a result, it is unproblemmatically possible to place the radiation receiver 5 under a patient or, as in the example shown in FIG. 1, in a drawer 10 of the patient table 7 fashioned as a Bucky table. In addition (see FIG. 3), arbitrary other employment possibilities are possible. In the example shown in FIG. 3, the radiation receiver 5 is positioned, for example, under the calves; the radiation source 4 arranged at the ceiling is positioned opposite thereto. Here as well, communication ensues between the control device 2 and the radiation receiver 5 via corresponding transmission and reception units 8, 9.

FIG. 2 shows the radiation receiver 5 in a schematic illustration. In addition to the upper, active region 11 wherein the scintilator, the pixel matrix and the read-out electronics, etc., are provided, the receiver also contains the transmission and reception unit 9 as well as an integrated power supply 12, which is formed by accumulators in the illustrated exemplary embodiment. These accumulators can be recharged in a charging station 13 at the central control device 2. When the radiation receiver is not in use, this is simply introduced into the charging station 13, as illustrated with the radiation receiver 5 indicated with broken lines. Via a suitable connector 14, an electrical connection is automatically produced between the integrated power supply 12 and the charging station 13, so that the accumulators are charged.

Alternatively or in addition, an electrical contact to an external power supply can be produced via the connection means 14, i.e. a mains cable can be connected as needed to the connector 14, to supply the supply voltage needed for the operation of the radiation receiver. The receiver can be used with a hard wired voltage supply, for example, as illustrated in FIG. 3. It is also possible to connect the radiation receiver 5, introduced into the drawer 10, with a supply terminal provided thereat via the connector 14 in FIG. 1, the radiation receiver 5 being then operated via this supply terminal or the integrated accumulators being able to be charged from this terminal.

As described, the transmission and reception units 8, 9 are fashioned as radio units. Expediently, blue tooth signals or DECT signals are employed. As an alternative, the transmission and reception units 8, 9 can be optical transmission and reception units, for example for the transmission of infrared signals. It is important that a bidirectional signal transfer ensues so that the transmission and reception unit 8 at the control device 2 can provide suitable control instructions to the radiation receiver 5 in order, for example, to activate it or to implement a reset before the image registration, and in order to receive corresponding answerbacks or to enable the image signal transfer to the control device 2.

Although modifications and changes may be suggested by those skilled in the art, it is the intention of the inventor to embody within the patent warranted hereon all changes and modifications as reasonably and properly come within the scope of his contribution to the art.

I claim as my invention:

1. An X-ray installation comprising:
a radiation source;
a transportable radiation receiver comprising a solid-state detector for generating image data dependent on radiation incident thereon from said radiation source;
a mobile central control device for operating said radiation receiver and for processing said image data; and
a wireless communication link between said radiation receiver and said control device via which at least said image data are wirelessly transmitted.

2. An X-ray installation as claimed in claim 1 wherein said wireless communication link is a bidirectional communication link additionally allowing transmission of control signals from said control device to said radiation receiver.

3. An X-ray installation as claimed in claim 1 wherein said wireless communication link is a radio communication link.

4. An X-ray installation as claimed in claim 3 wherein said wireless communication link is formed by a first transmission and reception unit at said control device and a second transmission and reception unit at said radiation receiver, said first and second transmission and reception units communicating with each other using signals selected from the group consisting of blue tooth signals and DECT signals.

5. An X-ray installation as claimed in claim 1 wherein said communication link is an optical communication link.

6. An X-ray installation as claimed in claim 1 wherein said radiation receiver includes power consuming components, and further comprises an integrated power supply connected to said power consuming components.

7. An X-ray installation as claimed in claim 6 wherein said integrated power supply comprises at least one power supply component selected from the group consisting of batteries and accumulators.

8. An X-ray installation as claimed in claim 7 wherein said power supply comprises at least one accumulator, and wherein said mobile central control device comprises a charging station adapted to receive said radiation receiver therein for charging said at least one accumulator.

9. An X-ray installation as claimed in claim 6 wherein said radiation receiver further comprises a unit for inductively feeding supply voltage to said power consuming components, in addition to said integrated power supply.

10. An X-ray installation as claimed in claim 6 wherein said radiation receiver further comprises a unit for capacitively feeding supply voltage to said power consuming components, in addition to said integrated power supply.

11. An X-ray installation as claimed in claim 6 wherein said radiation receiver further comprises a connector for producing a connection between said power consuming components and a power supply network, in addition to said integrated power supply.

12. An X-ray installation as claimed in claim 11 further comprising a Bucky table having a drawer therein containing a terminal connected to an external power supply, said radiation receiver being adapted for insertion into and removal from said drawer with simultaneous connection to and disconnection from said terminal.

13. An X-ray installation as claimed in claim 11 wherein said radiation receiver comprises a switch for automatically operating said power consuming components from said terminal when said radiation receiver is in said drawer and connected to said terminal, and for automatically operating said power consuming components with said integrated power supply when said radiation receiver is removed from said drawer and disconnected from said terminal.

14. An X-ray installation as claimed in claim 12 wherein said integrated power supply comprises at least one accumulator, and wherein said drawer in said Bucky table comprises a charging station with a further terminal to which said at least one accumulator is automatically connected when said radiation receiver is in said drawer, for charging said at least one accumulator.

15. An X-ray installation as claimed in claim 12 wherein said integrated power supply comprises at least one accumulator, and wherein said accumulator is charged from said external power supply when said radiation receiver is in said drawer.
